(19) United States
(12) Patent Application Publication
(10) Pub. No.: US 2023/0142233 A1
(43) Pub. Date: May 11, 2023

(54) ETCHING METHOD FOR RESIN MOLDED ARTICLE AND ETCHING PROCESS SYSTEM FOR RESIN MOLDED ARTICLE

(71) Applicant: KURITA WATER INDUSTRIES LTD., Tokyo (JP)

(72) Inventors: Haruyoshi YAMAKAWA, Tokyo (JP); Hajime ISERl, Tokyo (JP); Yuzuki YAMAMOTO, Tokyo (JP)

(73) Assignee: KURITA WATER INDUSTRIES LTD., Tokyo (JP)

(21) Appl. No.: 17/912,954

(22) PCT Filed: Sep. 15, 2020
(86) PCT No.: PCT/JP2020/034958

§ 371 Date: Sep. 20, 2022

(30) Foreign Application Priority Data
Apr. 28, 2020 (JP) 2020-079328

(51) Int. Cl. C23C 18/24; C23C 18/32

(52) U.S. Cl. CPC C23C 18/24; C23C 18/32

(57) ABSTRACT

The processing system (1) is provided with an etching tank (2) and a circulation pipe (7) that exits from the bottom portion of the etching tank (2) and returns to the etching tank (2). The circulation pipe (7) is provided with a liquid feed pump (8), a heat exchanger (9), a sulfuric acid concentration meter (10), and an oxidant concentration meter (11). The sulfuric acid concentration meter (10) and the oxidant concentration meter (11) can transmit measurement results to a calculation/control device (12). The etching tank (2) can be replenished with hydrogen peroxide water, sulfuric acid, and pure water through a hydrogen peroxide water supply line (13), a sulfuric acid supply line (14), and a pure water supply line (15). The calculation/control device (12) can adjust the supply amounts of hydrogen peroxide water, sulfuric acid, and pure water to respective desired amounts. Such a processing system enables etching of a resin molded article while maintaining both the sulfuric acid concentration and the oxidant concentration of a sulfuric acid solution that is free from hexavalent chromic acid or permanganic acid and contains an oxidizing substance obtained by mixing sulfuric acid and hydrogen peroxide water.

### TECHNICAL FIELD

The present invention relates to an etching method and an etching system using a sulfuric acid solution containing an oxidizing substance obtained by mixing sulfuric acid and hydrogen peroxide water in an etching process that is performed prior to the washing and modification of the surfaces of resin molded articles of various materials, in particular performed prior to the plating process for the surfaces of plastic materials.

### BACKGROUND ART

Conventionally, when metal plating is applied to the surface of a resin molded article, an etching step is performed before the plating process to roughen the resin molded article surface with a solution containing hexavalent chromic acid in order to increase the interfacial adhesion between the resin molded article surface and the plating film. However, the hexavalent chromium is designated as a carcinogenic substance and there are regulations on its use and discharge; therefore, there is a demand for an alternative technique that has less burden on the human body and the environment. As an alternative technique, etchants for resin molded articles using permanganic acid have been proposed (Patent Documents 1, 2, and 3, etc.). Unfortunately, permanganic acid is also designated as a Class 1 Designated Chemical Substance under the PRTR system as a chemical substance that may be harmful to the human health and ecosystems, and there is a demand for an etching technique that can further reduce the environmental burden.

To this end, as a technique for etching the surface of a resin molded article without containing such heavy metals that have burden on the human body and the environment, a processing system has been proposed in which sulfuric acid is electrolyzed and the electrolyzed liquid containing persulfuric acid is circulated (Patent Document 4). This processing system has less burden on the human body and the environment and provides stable processing effects for a long period of time, but there is a problem in that a large amount of electric power is necessary to electrolyze sulfuric acid and it is also necessary to ensure space for the device installation and to lay/enhance auxiliary facilities. Patent Document 4 also discloses, as a technique similar to the above, a method of etching the surface of a resin molded article with sulfuric acid containing persulfuric acid obtained by mixing concentrated sulfuric acid and hydrogen peroxide water. This method allows excellent interfacial adhesion to be obtained similar to that obtained when a plating process is performed after etching with the electrolyzed liquid of sulfuric acid. However, it is described that there is a problem in the long-term stability of processing due to the consumption of the added hydrogen peroxide.

Furthermore, a method of etching a resin molded article with a solution in which a persulfate is dissolved as a persulfate component has been proposed (Patent Document 5). In this method, it is possible to maintain an appropriate concentration of persulfuric acid in the etchant by adding persulfate. However, an operation or facility is necessary to dissolve a solid, such as sodium persulfate, potassium persulfate, or ammonium persulfate, which is added as persulfate. In addition, it is unavoidable that cation components other than hydrogen ions are mixed in due to the persulfate to be added, and there is a problem in that, as the addition is repeated and the concentration of the cation components increases, troubles may occur that the cations are precipitated/deposited as sulfate in the etching tank.

In the meanwhile, techniques of mixing sulfuric acid and hydrogen peroxide to generate persulfuric acid and using the resulting chemical liquid have been conventionally used as washing techniques for electronic components such as semiconductors, and various techniques for improving the stability of chemical liquid have been proposed (Patent Documents 6 and 7). These techniques are, however, techniques for their own purposes, such as a technique for maintaining the sulfuric acid concentration above a predetermined concentration and a technique for maintaining the persulfuric acid concentration within a predetermined range, and there is a problem in that these techniques are not directed to a use method and a processing system for a chemical liquid that simultaneously maintain the sulfuric acid concentration and the persulfuric acid concentration at predetermined concentrations.

### PRIOR ART DOCUMENTS

### Patent Documents

[Patent Document 1] JP6482049B

[Patent Document 2] JP6622712B

[Patent Document 3] JP2017-101304A

[Patent Document 4] JP2019-44229A

[Patent Document 5] JP6288213B

[Patent Document 6] JP2007-123330A

[Patent Document 7] JP2007-260516A

### SUMMARY OF THE INVENTION

### Problems to Be Solved by the Invention

Thus, the solution obtained by mixing sulfuric acid and hydrogen peroxide water has less burden on the human body and the environment and can moderately roughen the surface of a resin molded article to obtain excellent interfacial adhesion, but there is a problem in that it is difficult to simultaneously maintain the oxidant concentration and the sulfuric acid concentration at appropriate concentrations due to the decomposition of the oxidant obtained by mixing them and the accompanying decrease in the sulfuric acid concentration. Moreover, the processing system in which sulfuric acid is electrolyzed and the electrolyzed liquid containing persulfuric acid is circulated and supplied can obtain stable processing effects for a long period of time, but there is a problem in that a large amount of electric power is necessary to electrolyze sulfuric acid and it is also necessary to ensure space for the device installation and to lay/enhance auxiliary facilities. Furthermore, even in the method of adding persulfate, there is a problem in that precipitation/deposition of sulfate occurs due to the accumulation of cation components other than hydrogen ions, and stable processing cannot be performed for a long period of time.

The present invention has been made in view of the above problems, and an object of the present invention is to provide an etching method for etching a resin molded article and an etching process system for carrying out this method through maintaining both the sulfuric acid concentration and the oxidant concentration of a sulfuric acid solution that is free from hexavalent chromic acid or permanganic acid and contains an oxidizing substance obtained by mixing sulfuric acid and hydrogen peroxide water.

### Means for Solving the Problems

To achieve the above object, first, the present invention provides an etching method for a resin molded article, the etching method being a processing method of etching the resin molded article using a sulfuric acid solution as an etchant, the sulfuric acid solution containing an oxidant component obtained by mixing sulfuric acid having a concentration of 70 to 98 wt% and hydrogen peroxide water, the etching method comprising: continuously or intermittently measuring an oxidant concentration and a sulfuric acid concentration of the etchant; and controlling, based on the measured oxidant concentration and sulfuric acid concentration, the etchant to have a sulfuric acid concentration and an oxidant concentration suitable for etching the resin molded article (Invention 1).

In the step of etching the resin molded article, the concentration of oxidant in the etchant decreases and the sulfuric acid concentration varies with time, and the roughened state of the surface of the resin molded article may thereby be different. According to the invention (Invention 1), the resin molded article can be etched under a stable condition through measuring the oxidant concentration and sulfuric acid concentration of the etchant and appropriately adding sulfuric acid, hydrogen peroxide water, or the like in accordance with the measured concentrations of oxidant and sulfuric acid so that both the sulfuric acid concentration and the oxidant concentration of the etchant are appropriate.

In the above invention (Invention 1), it may be preferred to add hydrogen peroxide water to the etchant when the oxidant concentration of the etchant becomes a predetermined concentration or less (Invention 2).

The oxidant concentration of the etchant decreases as the etching process progresses. According to the invention (Invention 2), the oxidant concentration can be controlled to an appropriate concentration for etching through measuring the oxidant concentration of the etchant and, when it falls below the predetermined concentration, adding an appropriate amount of hydrogen peroxide water thereby to increase the oxidant concentration.

In the above invention (Invention 1, 2), it may be preferred to add sulfuric acid having a predetermined concentration or more to the etchant when the sulfuric acid concentration of the etchant becomes a predetermined concentration or less (Invention 3).

The sulfuric acid concentration of the etchant decreases due to the generation of an oxidant component and/or the addition of hydrogen peroxide water. According to the invention (Invention 3), the sulfuric acid concentration can be controlled to an appropriate concentration for etching through measuring the sulfuric acid concentration of the etchant and, when it falls below the predetermined concentration, adding an appropriate amount of sulfuric acid having the initial sulfuric acid concentration or more thereby to increase the sulfuric acid concentration.

In the above invention (Invention 1 to 3), it may be preferred to add water and/or hydrogen peroxide water to the etchant when the sulfuric acid concentration of the etchant becomes a predetermined concentration or more (Invention 4).

The sulfuric acid concentration of the etchant may rise above the predetermined concentration due to condensation as the etching process progresses and/or replenishment with sulfuric acid having a concentration of 70 to 98 wt%, and in this case the etching condition will vary. According to the invention (Invention 4), the sulfuric acid concentration can be controlled to an appropriate concentration for etching through measuring the sulfuric acid concentration of the etchant and, when it rises above the predetermined concentration, adding an appropriate amount of water and/or hydrogen peroxide water to the etchant thereby to reduce the sulfuric acid concentration without unduly increasing the oxidant concentration.

In the above invention (Invention 1 to 4), it may be preferred to control the sulfuric acid concentration and oxidant concentration of the etchant through: calculating, based on a measured value of the oxidant concentration, an amount of hydrogen peroxide water that allows the etchant to have a predetermined oxidant concentration; calculating, based on a measured value of the sulfuric acid concentration, an amount of sulfuric acid that allows the etchant to have a predetermined sulfuric acid concentration from a ratio of water to the sulfuric acid having a concentration of 70 to 98 wt% to be added; calculating an amount of water to be added from the obtained ratio of water and the obtained amount of hydrogen peroxide water; and adding one or more of the hydrogen peroxide water, water, and sulfuric acid based on the calculation results (Invention 5).

According to the invention (Invention 5), on the basis of the measured sulfuric acid concentration and oxidant concentration, the total amount of etchant, the concentration of sulfuric acid (ratio of water to sulfuric acid), and the concentrations of sulfuric acid and hydrogen peroxide water to be added, the amounts of hydrogen peroxide water, sulfuric acid, and water necessary (to be added) for optimizing the oxidant concentration and sulfuric acid concentration of the etchant may be calculated, and they can be appropriately added thereby to automate the control such that both the sulfuric acid concentration and the oxidant concentration of the etchant are appropriate.

Second, the present invention provides an etching process system for a resin molded article, comprising: a storage tank that stores, as an etchant, a sulfuric acid solution containing an oxidant component obtained by mixing sulfuric acid having a concentration of 70 to 98 wt% and hydrogen peroxide water; an oxidant concentration measuring means and a sulfuric acid concentration measuring means for the etchant; and an adjusting means that adjusts a sulfuric acid concentration and an oxidant concentration of the etchant (Invention 6).

In the step of etching the resin molded article, the concentration of the oxidant in the etchant decreases and the sulfuric acid concentration varies with time, and the roughened state of the surface of the resin molded article may thereby be different. According to the invention (Invention 6), the system can be configured which allows the resin molded article to be etched under a stable condition through measuring the oxidant concentration and the sulfuric acid concentration with the oxidant concentration measuring means and the sulfuric acid concentration measuring means and performing control with the adjusting means so as to appropriately add sulfuric acid, hydrogen peroxide water, or the like in accordance with the measured concentrations so that both the sulfuric acid concentration and the oxidant concentration of the etchant are appropriate.

In the above invention (invention 6), the adjusting means may preferably include a hydrogen peroxide water adding device (Invention 7).

The oxidant concentration of the etchant decreases as the etching process progresses. According to the invention (Invention 7), the oxidant concentration can be controlled to an appropriate concentration for etching through measuring the oxidant concentration of the etchant with the oxidant concentration measuring means and, when it falls below the predetermined concentration, performing control with the adjusting means so as to add an appropriate amount of hydrogen peroxide water thereby to increase the oxidant concentration.

In the above invention (Invention 6, 7), the adjusting means may preferably include a sulfuric acid adding device (Invention 8).

The sulfuric acid concentration of the etchant decreases due to the generation of an oxidant component and/or the addition of hydrogen peroxide water. According to the invention (Invention 8), the sulfuric acid concentration can be controlled to an appropriate concentration for etching through measuring the sulfuric acid concentration of the etchant with the sulfuric acid concentration measuring means and, when it falls below the predetermined concentration, performing control with the adjusting means so as to add an appropriate amount of sulfuric acid having the initial sulfuric acid concentration or more thereby to increase the sulfuric acid concentration.

In the above invention (Invention 6 to 8), the adjusting means may preferably include a water adding device (Invention 9).

The sulfuric acid concentration of the etchant may rise above the predetermined concentration due to condensation as the etching process progresses and/or replenishment with sulfuric acid having a concentration of 70 to 98 wt%, and in this case the etching condition will vary. On the other hand, if the sulfuric acid is diluted by adding hydrogen peroxide water, the oxidant concentration of the etchant will become unduly high. According to the invention (Invention 9), the sulfuric acid concentration can be controlled to an appropriate concentration for etching through measuring the sulfuric acid concentration of the etchant with the sulfuric acid concentration measuring means and, when it rises above the predetermined concentration, adding an appropriate amount of water thereby to reduce the sulfuric acid concentration without unduly increasing the oxidant concentration.

In the above invention (Invention 6 to 9), it may be preferred to provide a control means that controls the adjusting means based on measured values of the oxidant concentration measuring means and the sulfuric acid concentration measuring means (Invention 10).

According to the invention (Invention 10), the control means controls each adjusting means for adding sulfuric acid, hydrogen peroxide water, or water based on the measured values of the oxidant concentration measuring means and the sulfuric acid concentration measuring means, and the system can thereby be configured which enables automated control of the etchant capable of etching the resin molded article under a stable condition.

In the above invention (Invention 10), the control means may preferably perform control of: calculating, based on the measured value of oxidant concentration by the oxidant concentration measuring means, an amount of hydrogen peroxide water that allows the etchant to have a predetermined concentration of oxidant concentration; calculating, based on the measured value of sulfuric acid concentration, an amount of sulfuric acid that allows the etchant to have a predetermined sulfuric acid concentration from a ratio of water to the sulfuric acid having a concentration of 70 to 98 wt% to be added; calculating an amount of water to be added from the obtained ratio of water and the obtained amount of hydrogen peroxide water; and adding one or more of the hydrogen peroxide water, water, and sulfuric acid to the etchant based on the calculation results (Invention 11).

According to the invention (Invention 11), on the basis of the sulfuric acid concentration and oxidant concentration measured with the oxidant concentration measuring means and the sulfuric acid concentration measuring means, the total amount of etchant, the concentration of sulfuric acid (ratio of water to sulfuric acid), and the concentrations of sulfuric acid and hydrogen peroxide water to be added, the amounts of hydrogen peroxide water, sulfuric acid, and water necessary (to be added) for optimizing the oxidant concentration and sulfuric acid concentration of the etchant may be calculated in the control means, and they can be appropriately added thereby to automate the control of the system such that both the sulfuric acid concentration and the oxidant concentration of the etchant are appropriate.

### Advantageous Effect of the Invention

According to the etching method for a resin molded article of the present invention, the etchant is controlled to have a sulfuric acid concentration and an oxidant concentration suitable for etching the resin molded article based on the oxidant concentration and sulfuric acid concentration of the etchant; therefore, the resin molded article can be etched under a stable condition by appropriately adding sulfuric acid, hydrogen peroxide water, and water in accordance with the concentrations of oxidant and sulfuric acid so that both the sulfuric acid concentration and the oxidant concentration of the etchant are appropriate. Moreover, the burden on the human body and the environment is low because the processing can be performed in an environment that does not contain hexavalent chromic acid, permanganic acid, or the like.

### BRIEF DESCRIPTION OF DRAWINGS

FIG. 1 is a schematic diagram illustrating the configuration of an etching process system for a resin molded article according to an embodiment of the present invention;

FIG. 2 is an enlarged photograph showing the surface of a resin molded article after etching in Example 1.

FIG. 3 is a photograph showing the resin molded article after electroless nickel plating in Example 1.

FIG. 4 is an enlarged photograph showing the surface of a resin molded article after etching in Example 2.

FIG. 5 is an enlarged photograph showing the surface of a resin molded article after etching in Example 4.

FIG. 6 is an enlarged photograph showing the surface of a resin molded article after etching in Comparative Example 1.

FIG. 7 is an enlarged photograph showing the surface of a resin molded article after etching in Comparative Example 2.

FIG. 8 is an enlarged photograph showing the surface of a resin molded article after etching in Comparative Example 3.

FIG. 9 is a photograph showing the resin molded article after electroless nickel plating in Comparative Example 3.

FIG. 10 is a graph illustrating changes over time in sulfuric acid concentration in Examples 1 to 4 and Comparative Examples 1 to 4.

FIG. 11 is a graph illustrating changes over time in oxidant concentration in Examples 1 to 4 and Comparative Examples 1 to 4.

### EMBODIMENTS FOR CARRYING OUT THE INVENTION

Hereinafter, the present invention will be described in detail with reference to the accompanying drawings.

### Resin Molded Article

In the present embodiment, the resin molded article to be processed is not particularly limited, provided that it is made of a synthetic resin, but suitable examples include molded bodies made of resins such as ABS-based resins, polycarbonate (PC), polypropylene (PP), and polyphenylene sulfide (PPS). Among these, ABS-based resins may be particularly suitable. ABS-based resins as referred to in the present specification include not only an acrylonitrile-butadiene-styrene copolymer resin (ABS resin) alone, but also a blended resin of the ABS resin and one or more other resins, specifically a mixed resin of the ABS resin and polycarbonate (PC). In particular, ABS-based resins include a PC/ABS mixed resin containing 20 to 70 wt% of PC with respect to a total of 100 wt% of ABS resin and PC resin.

### Etching Process System for Resin Molded Article

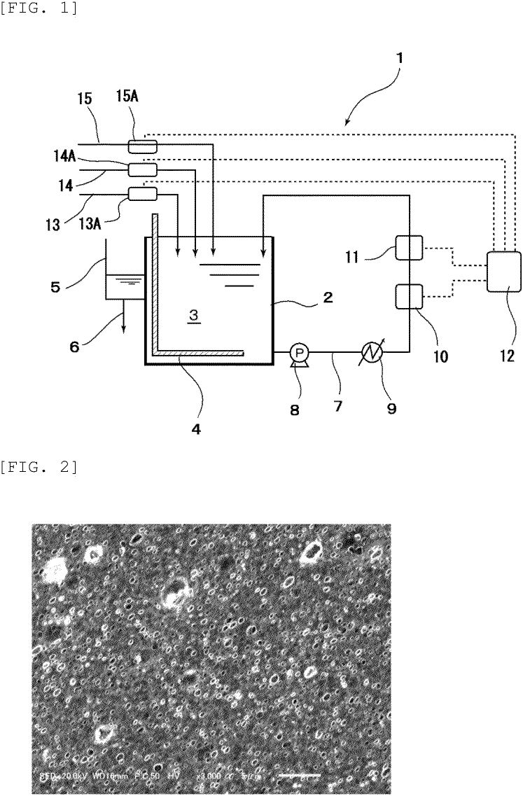

FIG. 1 illustrates an etching process system for a resin molded article according to an embodiment of the present invention. In FIG. 1, an etching process system 1 for a resin molded article includes an etching tank 2 that receives an etchant 3, a heater 4 disposed in the etching tank 2, an overflow tank 5 provided adjacent to the etching tank 2, and a drain pipe 6 connected to the overflow tank 5. The etching tank 2 is provided with a circulation pipe 7 that exits from the bottom portion of the etching tank 2 and returns to the etching tank 2. The circulation pipe 7 is provided with a liquid feed pump 8, a heat exchanger 9, a sulfuric acid concentration meter 10 as a sulfuric acid concentration measuring means, and an oxidant concentration meter 11 as an oxidant concentration measuring means in this order from the outlet side (base end side). The sulfuric acid concentration meter 10 and the oxidant concentration meter 11 can transmit measurement results to a calculation/control device 12 as a control means.

On the other hand, in FIG. 1, reference numeral 13 represents a hydrogen peroxide water supply line as a hydrogen peroxide water adding device equipped with a flowmeter 13A for hydrogen peroxide water, reference numeral 14 represents a sulfuric acid supply line as a sulfuric acid adding device equipped with a flowmeter 14A for sulfuric acid, and reference numeral 15 represents a pure water supply line as a pure water adding device equipped with a flowmeter 15A for pure water. The hydrogen peroxide water supply line 13, the sulfuric acid supply line 14, and the pure water supply line 15 can replenish the etching tank 2 with desired amounts of hydrogen peroxide water, sulfuric acid, and pure water, respectively. The hydrogen peroxide water supply line 13 and its flowmeter 13A, the sulfuric acid supply line 14 and its flowmeter 14A, and the pure water supply line 15 and its flowmeter 15A constitute respective adjusting means. The flowmeters 13A, 14A, and 15A can transmit the measurement results to the calculation/control device 12, which can adjust the desired amounts of hydrogen peroxide, sulfuric acid, and pure water to be supplied.

### Sulfuric Acid Concentration Measuring Means

The method of measuring the concentration of sulfuric acid in the sulfuric acid concentration measuring means is not particularly limited, provided that the concentration of sulfuric acid can be measured accurately, and a neutralization titration method, a specific gravity measurement method, an electromagnetic induction method, an in-liquid ultrasonic propagation velocity measurement method, etc. can be applied.

### Oxidant Concentration Measuring Means

The method of measuring the concentration of oxidant in the oxidant concentration measuring means is not particularly limited, provided that the oxidant concentration can be measured accurately, and a redox titration method, an absorption photometry method, a method of measuring the amount of oxygen gas generated by thermal decomposition, etc. can be applied. Additionally or alternatively, methods of measuring the oxidant concentration, such as described in JP5499602B, JP5773132B, JP5710345B, JP6024936B, and JP6265289B, can be applied to the method of measuring the oxidant concentration in an environment of high sulfuric acid concentration as in the present embodiment.

### Etchant

The etchant 3 may have to contain a persulfuric acid (peroxomonosulfuric acid) component having strong oxidizing properties. The persulfuric acid may be generated through the reaction of Formula (1) as below by mixing sulfuric acid and hydrogen peroxide.

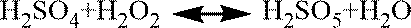

The sulfuric acid in the reaction of the above Formula (1) is molecular sulfuric acid, so the sulfuric acid concentration may have to allow the molecular sulfuric acid to exist. In the etchant 3, therefore, the sulfuric acid concentration needs to be 70 wt% or more. From another aspect, sulfuric acid having a concentration of 98 wt% or more generates a remarkably large amount of sulfurous acid gas and is difficult to handle, so the sulfuric acid concentration may be 70 to 98 wt%. The sulfuric acid concentration of the etchant 3 when etching a resin molded article may be preferably 75 to 90 wt%, but the present invention is not particularly limited to this, and an appropriate concentration condition may be set within a sulfuric acid concentration range of 70 to 98 wt% depending on the resin material to be applied.

For the hydrogen peroxide water blended in the etchant 3, hydrogen peroxide water having any concentration, such as 35 wt% hydrogen peroxide water used as a general industrial chemical, can be used, but it may be preferred to use a high-concentration hydrogen peroxide water because the additive amount required to obtain a set value of the oxidant concentration in the etchant 3 is small.

If the oxidant concentration of the etchant 3 thus obtained by mixing sulfuric acid and hydrogen peroxide water is less than 10 mmol/L as O, sufficient etching effects on the resin molded article cannot be expected, while if the oxidant concentration exceeds 500 mmol/L as O, control for homogeneous etching will be difficult; therefore, the oxidant concentration may be 10 to 500 mmol/L as O and preferably 25 to 250 mmol/L as O. In the present embodiment, the oxidant concentration refers to a total oxidizing substance concentration measured by an iodine titration method. The iodine titration method refers to a method that includes adding KI to a small amount of a test liquid to liberate I₂, titrating the I₂ with a Na2S₂O₃ standard solution to obtain the amount of I₂, and obtaining an oxidant concentration from the amount of I₂. In the present embodiment, preferably, the etchant 3 does not substantially contain heavy metals such as hexavalent chromic acid and permanganate that have burden on the human body and the environment.

### Etching Method for Resin Molded Article

The etching method for a resin molded article using the etching process system 1 as above will then be described.

First, the above-described hydrogen peroxide water and sulfuric acid from the hydrogen peroxide water supply line 13 and the sulfuric acid supply line 14 and, if necessary, pure water for adjustment, are supplied to the etching tank 2 so as to have the above-described sulfuric acid concentration and oxidant concentration. This allows the sulfuric acid and hydrogen peroxide to react, and the etchant 3 containing persulfuric acid as the oxidant is stored. During this operation, the temperature of the etchant 3 in the etching tank 2 is not particularly limited, provided that an appropriate etching action can be obtained, but if the temperature is unduly low, the etching reaction will not progress easily, while if the temperature of the etchant 3 is unduly high, shape deformation such as softening may occur depending on the type of resin, and it is therefore preferred to set the temperature to 40° C. to 80° C., such as by using the heater 4. The temperature of the etchant 3 may be adjusted by controlling the heater 4 using a temperature sensor (not illustrated) provided in the etching tank 2. In this operation, to adjust the sulfuric acid concentration to a predetermined concentration, if only the addition of hydrogen peroxide water is performed, the oxidant concentration will be unduly high, so water may be added to dilute the sulfuric acid. Tap water may be used for the water to be added, but it may be preferred to use pure water as in the present embodiment in order to avoid various cations and anions from being mixed into the solution. As a method of adding water, in the present embodiment, water is directly added to the etching tank 2, but another method may also be adopted, such as a method in which water is injected into the circulation pipe 7 or a method in which water is added to a concentration adjusting tank provided separately and circulation is performed between the etching tank 2 and the concentration adjusting tank.

Then, the etching process can be performed through immersing a resin molded article in the etching tank 2 and taking out the resin molded article after a predetermined time has passed. This etching process may be repeated.

By heating the etchant and repeating the etching process, the amount of the etchant 3 decreases due to adhesion to the resin molded article, and the sulfuric acid concentration and the oxidant concentration vary. In the present embodiment, therefore, to obtain appropriate etching effects, the etchant 3 is circulated through the circulation pipe 7, and the sulfuric acid concentration and the oxidant concentration are constantly or intermittently measure by the sulfuric acid concentration meter 10 and the oxidant concentration meter 11, respectively. Then, the measurement results are used as the basis for the calculation/control device 12 to calculate, also based on the flow rate measurement data of the flowmeters 13A, 14A, and 15A, the supply amounts from the hydrogen peroxide water supply line 13, the sulfuric acid supply line 14, and the pure water supply line 15, thereby maintaining the sulfuric acid concentration and the oxidant concentration within the previously described appropriate ranges.

Specifically, the sulfuric acid concentration of the etchant 3 is lowered by adding hydrogen peroxide water, and appropriate etching effects may not be obtained. In the present embodiment, therefore, to obtain appropriate etching effects, when the measured value of the sulfuric acid concentration of the sulfuric acid concentration meter 10 falls below a predetermined value, sulfuric acid may be added from the sulfuric acid supply line 14 based on the measured value of the sulfuric acid concentration of the sulfuric acid concentration meter 10 and the amount of the etchant 3 in the etching tank 2 so that the sulfuric acid concentration in the etchant 3 becomes a predetermined concentration. Here, the sulfuric acid to be added is not particularly limited, provided that its concentration is higher than the sulfuric acid concentration of the etchant, and the sulfuric acid used for preparation of the previously described etchant 3 may therefore be added. For example, high-concentration sulfuric acid such as 97% sulfuric acid, which is commonly used as an industrial chemical, may be more preferred because the additive amount to achieve the sulfuric acid concentration in the etchant to be set is small. For this addition of sulfuric acid, in the present embodiment, sulfuric acid is directly added to the etching tank 2, but another method may also be adopted, such as a method in which sulfuric acid is injected into the circulation pipe 7 or a method in which sulfuric acid is added to a concentration adjusting tank provided separately and circulation is performed between the etching tank 2 and the concentration adjusting tank.

On the other hand, the sulfuric acid concentration of the etchant 3 increases due to condensation by heating, and appropriate etching effects may not be obtained. Therefore, when the measured value of the sulfuric acid concentration of the sulfuric acid concentration meter 10 exceeds a predetermined value, pure water may be supplied from the pure water supply line 15 or hydrogen peroxide water may be supplied from the hydrogen peroxide water supply line 13 based on the measured value of the sulfuric acid concentration of the sulfuric acid concentration meter 10, the amount of the etchant 3 in the etching tank 2, and the measured value of the oxidant concentration of the oxidant concentration meter 11 so that the sulfuric acid concentration in the etchant 3 becomes a predetermined concentration. For this addition of water or hydrogen peroxide water, in the present embodiment, water or hydrogen peroxide water is directly added to the etching tank 2, but another method may also be adopted, such as a method in which water or hydrogen peroxide water is injected into the circulation pipe 7 or a method in which water or hydrogen peroxide water is added to a concentration adjusting tank provided separately and circulation is performed between the etching tank 2 and the concentration adjusting tank.

From another aspect, the oxidant concentration of the etchant 3 decreases as the etching process continues, and appropriate etching effects may not be obtained. In the present embodiment, therefore, when the value of the oxidant concentration of the oxidant concentration meter 11 falls below a predetermined value, hydrogen peroxide water may be supplied from the hydrogen peroxide water supply line 13 based on the measured value of the oxidant concentration of the oxidant concentration meter 11 and the amount of the etchant 3 in the etching tank 2 so that the oxidant concentration in the etchant 3 becomes a predetermined concentration. Here, the hydrogen peroxide water to be added may be the same as described previously. For this addition of hydrogen peroxide water, in the present embodiment, hydrogen peroxide water is directly added to the etching tank 2, but another method may also be adopted, such as a method in which hydrogen peroxide water is injected into the circulation pipe 7 or a method in which hydrogen peroxide water is added to a concentration adjusting tank provided separately and circulation is performed between the etching tank 2 and the concentration adjusting tank.

When replenishing a large amount of the etchant 3, such as replenishing the amount of liquid carried out by adhering to the etched resin molded article, water may be added for diluting sulfuric acid because the oxidant concentration exceeds a predetermined concentration only by adding sulfuric acid and hydrogen peroxide water in order to adjust the sulfuric acid concentration to a predetermined concentration.

For the control of the sulfuric acid concentration and oxidant concentration as described above, the calculation/control device 12 may calculate, based on the measured value of the sulfuric acid concentration meter 10, that is, based on the measured value of the sulfuric acid concentration, the ratio of water to the sulfuric acid to be added so that the etchant has a sulfuric acid concentration of a predetermined concentration. In addition, the calculation/control device 12 may calculate, based on the measured value of the sulfuric acid concentration meter 10, that is, based on the measured value of the sulfuric acid concentration, the ratio of water to the sulfuric acid to be added so that the etchant has a sulfuric acid concentration of a predetermined concentration. Furthermore, the amount of water to be added may be calculated from the ratio of water obtained by calculation and the calculated amount of hydrogen peroxide water. Then, the calculation/control device 12 may control the supply amounts from the hydrogen peroxide water supply line 13, the sulfuric acid supply line 14, and the pure water supply line 15 so as to add the hydrogen peroxide water, water, and sulfuric acid having respective amounts thus calculated.

For example, when the predetermined oxidant concentration of the etchant is A [mmol/L], the predetermined sulfuric acid concentration is B [wt%], the measured oxidant concentration is a [mmol/L], the measured sulfuric acid concentration is b [wt%], the amount of liquid stored in the entire etching process system 1 including the etching tank 2 is V [L], and the amount of liquid to be replenished is v [L], the additive amount x [L] of hydrogen peroxide water m [wt%], the additive amount Y [L] of sulfuric acid n [wt%], and the additive amount Z [L] of water can be determined by the following functions (2), (3), and (4).

$$\text{X = function} \left(\text{A,} \text{a,} \text{V,} \text{v,} \text{m}\right)$$

$$\text{Y = function} \left(\text{B,} \text{b,} \text{V,} \text{v,} \text{n}\right)$$

$$\text{Z = function} \left(\text{V,} \text{v,} \text{X,} \text{Y}\right)$$

More accurately, it may be preferred to take into account the influence of temperature conditions when performing the above calculations, but the calculation schemes for obtaining the additive amounts are not limited to these, and it suffices that the oxidant concentration and sulfuric acid concentration of the etchant are simultaneously maintained at respective predetermined concentrations. According to the etching method for a resin molded article of the present embodiment as described above, it is possible to perform the surface processing such as etching of a resin molded article stably for a long period of time without containing heavy metals such as hexavalent chromic acid and permanganate that have burden on the human body and the environment.

The present invention has been described hereinbefore based on the above embodiments, but the present invention is not limited to the above embodiments and various modifications can be carried out. For example, the present invention can be applied to continuous processing rather than batch processing as in the present embodiment. Moreover, as will be understood, the resin molded article can be applied to molded articles having various shapes.

### EXAMPLES

Examples and Comparative Examples will be illustrated below to describe the present invention more specifically. Note, however, that the present invention is not limited by these descriptions.

### Example 1

The etching process system 1 for a resin molded article illustrated in FIG. 1 was configured using the etching tank 2 (volume 10 L, liquid depth 250 mm) in which an immersion heater was put in as the heater 4. In this system 1, 7.5 L of 97 wt% sulfuric acid and about 3 L of pure water were added to the etching tank 2 to adjust the sulfuric acid concentration to 80 wt%. As the sulfuric acid concentration meter 10, measurement equipment for converting the ultrasonic wave propagation velocity into the sulfuric acid concentration was used. During the above operation, the temperature of sulfuric acid in the etching bath 2 was controlled to about 60° C. by cooling with the heat exchanger 9 and heating with the heater (heater 4). About 46 mL of 35 wt% hydrogen peroxide water was added to the sulfuric acid solution, and the etchant 3 was prepared using measurement equipment as the oxidant concentration meter 11 for converting UV absorbance to the total oxidant concentration to perform adjustment such that the oxidant concentration would be 50 mmol/L as O. The change in the sulfuric acid concentration due to the addition of hydrogen peroxide water was Δ0.1 wt% or less. Then, the temperature of the etchant 3 in the etching tank 2 was maintained at 60° C. by the heater (heater 4), and changes in the sulfuric acid concentration and oxidant concentration of the etchant 3 were measured for 24 hours. FIGS. 10 and 11 illustrate changes over time in the sulfuric acid concentration and the oxidant concentration. As apparent from FIGS. 10 and 11, in Example 1, the sulfuric acid concentration of the etchant 3 remained almost unchanged, and the oxidant concentration was 45 mmol/L as O, which decreased by about 10%.

Etching of a resin sample was carried out using the etchant 3 after 24 hours. As the resin sample, an ABS resin test piece (BULKSAM TM-25: 40 mm×130 mm×3 mmt) was used. FIG. 2 shows the surface state of the resin sample subjected to the etching process for 10 minutes. As apparent from FIG. 2, in Example 1, the surface of the resin sample was sufficiently etched.

In addition, the etched test piece was immersed in warm water at 50° C. for 10 minutes, and then further immersed in a neutralizing liquid (concentrated hydrochloric acid 50 mL/L, 35° C.) for 1 minute. Then, the test piece was immersed in a palladium-tin colloidal catalyst liquid (palladium concentration 0.11 g/L, tin concentration 10.7 g/L, concentrated hydrochloric acid 180 mL/L, 40° C.) for 2 minutes, washed with water, and thereafter immersed in an activation liquid (concentrated hydrochloric acid 100 mL/L, 40° C.) for 10 minutes to perform an activation process. After washing the test piece with water, it was immersed in an electroless nickel plating liquid (nickel concentration 8.0 g/L, pH 9.0, 40° C.) for 15 minutes. It has been confirmed that, as illustrated in FIG. 3, silver-colored nickel plating is deposited on the test piece subjected to the plating step described above.

### Example 2

The etching tank 2 was filled with the etchant 3 in the same manner as in Example 1 using the etching process system 1 having the same configuration as in Example 1. Then, the temperature of the etchant 3 in the etching tank 2 was controlled at 60° C., and for one batch of 20 sheets of the same resin samples as in Example 1, the etching process was carried out at a rate of one batch every 15 minutes. During this operation, about 80 mL of the etchant 3 was taken out per batch because the etchant 3 adhered to the resin samples, and the liquid depth of the etchant 3 in the etching tank 2 decreased by about 8 mm in one hour. Therefore, the calculation/control device 12 was activated, and the etching system 1 was operated for 24 hours to, when the liquid depth was lowered to 240 mm or less, automatically add 97 wt% sulfuric acid, 35 wt% hydrogen peroxide water, and pure water based on the measured values of the sulfuric acid concentration meter 10 and the oxidant concentration meter 11 so that the oxidant concentration would be 50 mmol/L as O at 0 wt% of the sulfuric acid concentration of the etchant 3. In this test, the total additive amount of sulfuric acid, hydrogen peroxide water, and pure water during liquid replenishment was set to 200 mL per time. In this operation, the additive amounts were controlled at about 143 mL of 97 wt% sulfuric acid, 5 to 6 mL of 35 wt% hydrogen peroxide water, and 51 to 52 mL of pure water in one replenishment.

As a result of the etching process, the number of processed resin samples was 1920, the additive amount of 97 wt% sulfuric acid was about 5.7 L, the additive amount of 35 wt% hydrogen peroxide water was about 0.2 L, the additive amount of pure water was about 2 L, and the amount of drain was zero. FIGS. 10 and 11 illustrate changes over time in the sulfuric acid concentration and the oxidant concentration, respectively, in Example 2. As apparent from FIGS. 10 and 11, in Example 2, the sulfuric acid concentration and oxidant concentration of the etchant 3 remained almost unchanged.

FIG. 4 shows the surface state of the resin sample processed with the etchant 3 after 24 hours. As apparent from FIG. 4, in Example 2, it has been confirmed that the surface of the resin sample is sufficiently etched even after 24 hours. It is thus found that stable etching effects are obtained by controlling, with the calculation/control device 12, the amounts of sulfuric acid, hydrogen peroxide water, and pure water in the replenishment liquid for the etchant 3 carried out due to the etching process for the resin molded articles (resin samples) so that appropriate sulfuric acid concentration and oxidant concentration are achieved.

### Example 3

The etching tank 2 was filled with the etchant 3 in the same manner as in Example 1 using the etching process system having the same configuration as in Example 1. In this operation, 20 ml of a copper (II) sulfate aqueous solution (500 mg/L as Cu) was added as an impurity to the etchant so that the Cu ion concentration in the etchant 3 would be 2 mg/L as Cu. The change in the sulfuric acid concentration due to the addition was Δ0.1 wt% or less.

After that, the oxidant concentration was expected to decrease due to the influence of the impurity; therefore, the calculation/control device 12 was activated, and the etching system 1 was operated for 24 hours to automatically add 97 wt% sulfuric acid and 35 wt% hydrogen peroxide water so that the oxidant concentration would be 50 mmol/L as O at 80 wt% of the sulfuric acid concentration of the etchant 3. As a result, the additive amount of 97 wt% sulfuric acid was about 2.5 L, the additive amount of 35 wt% hydrogen peroxide water was about 1 L, and the drain occurred in 24 hours was about 3.5 L. FIGS. 10 and 11 illustrate changes over time in the sulfuric acid concentration and the oxidant concentration, respectively, in Example 3. As apparent from FIGS. 10 and 11, in Example 3, the sulfuric acid concentration and oxidant concentration of the etchant 3 remained almost unchanged.

It has thus been confirmed that the sulfuric acid concentration and oxidant concentration of the etchant can be stably maintained by using this system even when an impurity that accelerates the decomposition of the oxidant is mixed.

### Example 4

After the etchant 3 was prepared as in Example 3, the temperature of the etchant 3 in the etching tank 2 was controlled at 60° C., and for one batch of 20 sheets of the same resin samples as in Example 1, the etching process was carried out at a rate of one batch every 15 minutes. During this operation, about 80 mL of the etchant 3 was taken out per batch because the etchant 3 adhered to the resin samples, and the liquid depth of the etchant 3 in the etching tank 2 decreased by about 8 mm in one hour. Therefore, the calculation/control device 12 was activated, and the etching system 1 was operated for 24 hours to, when the liquid depth was lowered to 240 mm or less, automatically add 97 wt% sulfuric acid, 35 wt% hydrogen peroxide water, and pure water based on the measured values of the sulfuric acid concentration meter 10 and the oxidant concentration meter 11 so that the oxidant concentration would be 50 mmol/L as O at 0 wt% of the sulfuric acid concentration of the etchant 3. In this test, the total additive amount of sulfuric acid, hydrogen peroxide water, and pure water during liquid replenishment was set to 200 mL per time. In this operation, the additive amounts were controlled at about 143 mL of 97 wt% sulfuric acid, 5 to 6 mL of 35 wt% hydrogen peroxide water, and 51 to 52 mL of pure water in one replenishment.

As a result, the number of processed resin samples was 1920, the additive amount of 97 wt% sulfuric acid was about 5.7 L, the additive amount of 35 wt% hydrogen peroxide water was about 0.2 L, the additive amount of pure water was about 2 L, and the amount of drain was zero. FIGS. 10 and 11 illustrate changes over time in the sulfuric acid concentration and the oxidant concentration, respectively, in Example 2. As apparent from FIGS. 10 and 11, in Example 4, the sulfuric acid concentration and oxidant concentration of the etchant 3 remained almost unchanged.

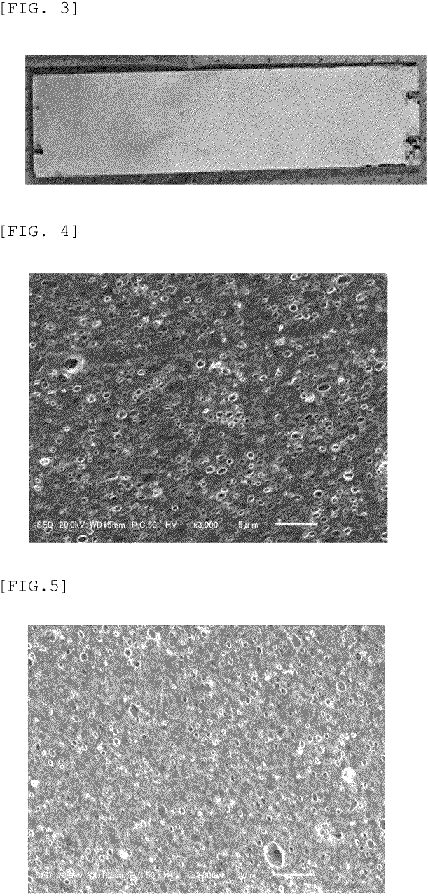

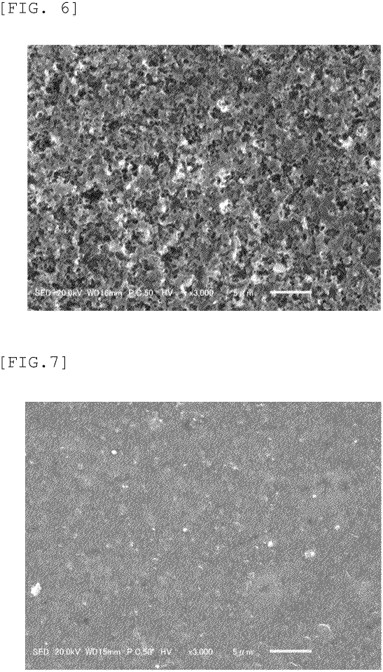

FIG. 5 shows the surface state of the resin sample processed with the etchant 3 after 24 hours. As apparent from FIG. 5, in Example 4, it has been confirmed that the surface of the resin sample is sufficiently etched even after 24 hours. It is thus found that stable etching effects are obtained by controlling, with the calculation/control device 12, the amounts of sulfuric acid, hydrogen peroxide water, and pure water in the replenishment liquid for the etchant 3 carried out due to the etching process for the resin molded articles (resin samples) so that appropriate sulfuric acid concentration and oxidant concentration are achieved.

### Comparative Example 1

As in Example 2, for one batch of 20 sheets of the same resin samples, the etching process was carried out at a rate of one batch every 15 minutes. To maintain only the sulfuric acid concentration at 80 wt%, only 97 wt% sulfuric acid and 35 wt% hydrogen peroxide water were used to replenish the etchant taken out, and the etching system 1 was operated without adding pure water. In this test, the total additive amount of sulfuric acid, hydrogen peroxide water, and pure water during liquid replenishment was set to 200 mL per time. In this operation, the additive amounts were set to about 143 mL of 97 wt% sulfuric acid and about 57 mL of 35 wt% hydrogen peroxide water in one replenishment. FIGS. 10 and 11 illustrate changes over time in the sulfuric acid concentration and the oxidant concentration, respectively, in Comparative Example 1. As apparent from FIGS. 10 and 11, in Comparative Example 1, the sulfuric acid concentration remained unchanged after 6 hours from the start of processing, but the oxidant concentration increased to 250 mmol/L or more, so the etching process system 1 for resin molded articles was stopped.

FIG. 6 shows the surface state of the resin sample processed with the etchant 3 after 6 hours. As apparent from FIG. 6, the surface of the resin sample was severely etched, and the surface condition was significantly different from that of the resin sample of Example 1 shown in FIG. 2. It has thus been confirmed that even when the sulfuric acid concentration is the same, if the oxidant concentration is not controlled, the variation in product quality after etching is large.

### Comparative Example 2

As in Example 2, for one batch of 20 sheets of the same resin samples, the etching process was carried out at a rate of one batch every 15 minutes. To maintain only the sulfuric acid concentration at 80 wt%, only 97 wt% sulfuric acid and pure water were used to replenish the etchant taken out, and the etching system 1 was operated without adding 35 wt% hydrogen peroxide water. In this test, the total additive amount of sulfuric acid and pure water during liquid replenishment was set to 200 mL per time. In this operation, the additive amounts were set to about 143 mL of 97 wt% sulfuric acid and about 57 mL of pure water in one replenishment. FIGS. 10 and 11 illustrate changes over time in the sulfuric acid concentration and the oxidant concentration, respectively, in Comparative Example 2. As apparent from FIGS. 10 and 11, in Comparative Example 2, the sulfuric acid concentration remained unchanged after 24 hours from the start of processing, but the oxidant concentration decreased to about 10 mmol/L.

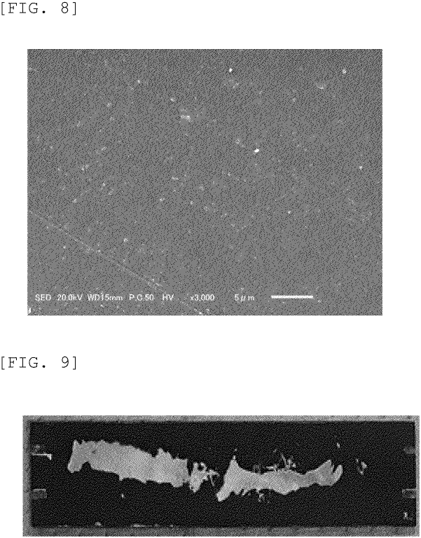

FIG. 7 shows the surface state of the resin sample processed with the etchant 3 after 24 hours. As apparent from FIG. 7, the etching effect on the resin sample was obviously weaker than the surface state of the resin sample of Example 1 shown in FIG. 2. It has thus been confirmed that an appropriate resin etching action cannot be obtained unless the sulfuric acid concentration and the oxidant concentration are simultaneously controlled within respective appropriate concentration ranges.

### Comparative Example 3

As in Example 2, for one batch of 20 sheets of the same resin samples, the etching process was carried out at a rate of one batch every 15 minutes. To maintain only the oxidant concentration at 50 mmol/L as O, only 35 wt% hydrogen peroxide water and pure water were used to replenish the etchant taken out, and the etching system 1 was operated without adding 97 wt% sulfuric acid. In this test, the total additive amount of hydrogen peroxide water and pure water during liquid replenishment was set to 200 mL per time. In this operation, the additive amounts were set to about 10 mL of 35 wt% hydrogen peroxide water and 190 mL of pure water in one replenishment. FIGS. 10 and 11 illustrate changes over time in the sulfuric acid concentration and the oxidant concentration, respectively, in Comparative Example 3. As apparent from FIGS. 10 and 11, in Comparative Example 3, the oxidant concentration remained unchanged, but the sulfuric acid concentration decreased to 70 wt% or less after 12 hours from the start of processing, so the etching process system 1 for resin molded articles was stopped.

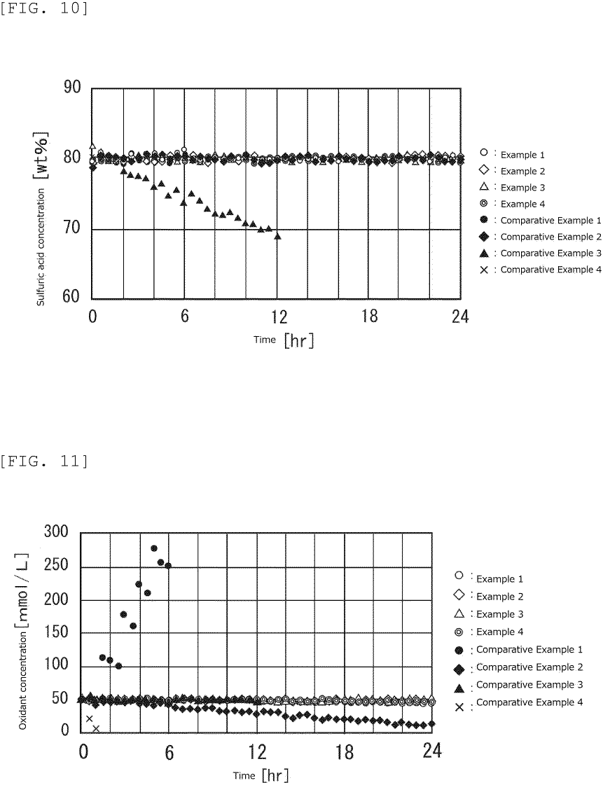

FIG. 8 shows the surface state of the resin sample processed with the etchant 3 after 12 hours. As apparent from FIG. 8, almost no etching effect was observed on the resin sample. In addition, when the plating process was performed under the same conditions as in Example 1, as shown in FIG. 9, the area in which the Ni plating was not deposited (black-colored area in FIG. 9) was large, and the deposition of the plating was incomplete. It has thus been confirmed that an appropriate resin etching action cannot be obtained unless the oxidant concentration and the sulfuric acid concentration are simultaneously controlled within respective appropriate concentration ranges.

### Comparative Example 4

The calculation/control device 12 was not activated in Example 3, and the liquid temperature in the etching tank 2 was maintained at 60° C. FIGS. 10 and 11 illustrate changes over time in the sulfuric acid concentration and the oxidant concentration, respectively, in Comparative Example 4. As apparent from FIGS. 10 and 11, in Comparative Example 4, the sulfuric acid concentration remained almost unchanged, but the oxidant concentration decreased to about 5 mmol/L as O in 1 hour. It is thus found that if an impurity that promotes decomposition of the oxidant is mixed in, the sulfuric acid concentration and oxidant concentration of the etchant cannot be stably maintained unless this system is used, and etching defects may therefore occur.

### DESCRIPTION OF REFERENCE NUMERALS

1 Etching process system for resin molded article
2 Etching tank
3 Etchant
4 Heater
5 Overflow tank
6 Drain pipe
7 Circulation pipe
8 Liquid feed pump
9 Heat exchanger
10 Sulfuric acid concentration meter (sulfuric acid concentration measuring means)
11 Oxidant concentration meter (oxidant concentration measuring means)
12 Calculation/control device (control means)
13 Hydrogen peroxide water supply line (hydrogen peroxide water adding device)
13A Flowmeter for hydrogen peroxide water
14 Sulfuric acid supply line (sulfuric acid adding device)
14A Flowmeter for sulfuric acid
15 Pure water supply line (water adding device)
15A Flowmeter for pure water

1. An etching method for a resin molded article, the etching method being a processing method of etching the resin molded article using a sulfuric acid solution as an etchant, the sulfuric acid solution containing an oxidant component obtained by mixing sulfuric acid having a concentration of 70 to 98 wt% and hydrogen peroxide water, the etching method comprising:
continuously or intermittently measuring an oxidant concentration and a sulfuric acid concentration of the etchant; and
controlling, based on the measured oxidant concentration and sulfuric acid concentration, the etchant to have a sulfuric acid concentration and an oxidant concentration suitable for etching the resin molded article.

2. The etching method for a resin molded article according to claim 1, comprising,
when the oxidant concentration of the etchant becomes a predetermined concentration or less, adding hydrogen peroxide water to the etchant.

3. The etching method for a resin molded article according to claim 1, comprising,
when the sulfuric acid concentration of the etchant becomes a predetermined concentration or less, adding sulfuric acid having a predetermined concentration or more to the etchant.

4. The etching method for a resin molded article according to claim 1, comprising,
when the sulfuric acid concentration of the etchant becomes a predetermined concentration or more, adding water and/or hydrogen peroxide water to the etchant.

5. The etching method for a resin molded article according to claim 1, wherein controlling the sulfuric acid concentration and oxidant concentration of the etchant comprises:
calculating, based on a measured value of the oxidant concentration, an amount of hydrogen peroxide water that allows the etchant to have a predetermined oxidant concentration;
calculating, based on a measured value of the sulfuric acid concentration, an amount of sulfuric acid that allows the etchant to have a predetermined sulfuric acid concentration from a ratio of water to the sulfuric acid having a concentration of 70 to 98 wt% to be added;
calculating an amount of water to be added from the obtained ratio of water and the obtained amount of hydrogen peroxide water; and
adding one or more of the hydrogen peroxide water, water, and sulfuric acid based on the calculation results.

6. An etching process system for a resin molded article, comprising:
a storage tank that stores, as an etchant, a sulfuric acid solution containing an oxidant component obtained by mixing sulfuric acid having a concentration of 70 to 98 wt% and hydrogen peroxide water;
an oxidant concentration measuring means and a sulfuric acid concentration measuring means for the etchant; and
an adjusting means that adjusts a sulfuric acid concentration and an oxidant concentration of the etchant.

7. The etching process system for a resin molded article according to claim 6, wherein the adjusting means includes a hydrogen peroxide water adding device.

8. The etching process system for a resin molded article according to claim 6, wherein the adjusting means includes a sulfuric acid adding device.

9. The etching process system for a resin molded article according to claim 6, wherein the adjusting means includes a water adding device.

10. The etching process system for a resin molded article according to claim 6, further comprising;
a control means that controls the adjusting means based on measured values of the oxidant concentration measuring means and sulfuric the sulfuric acid concentration measuring means.

11. The etching process system for a resin molded article according to claim 10, wherein the control means performs control of:
calculating, based on the measured value of oxidant concentration by the oxidant concentration measuring means, an amount of hydrogen peroxide water that allows the etchant to have a predetermined concentration of oxidant concentration;
calculating, based on the measured value of sulfuric acid concentration, an amount of sulfuric acid that allows the etchant to have a predetermined sulfuric acid concentration from a ratio of water to the sulfuric acid having a concentration of 70 to 98 wt% to be added;
calculating an amount of water to be added from the obtained ratio of water and the obtained amount of hydrogen peroxide water; and
adding one or more of the hydrogen peroxide water, water, and sulfuric acid to the etchant based on the calculation results.
